(19) United States
(12) Patent Application Publication
(10) Pub. No.: US 2006/0147633 A1
(43) Pub. Date: Jul. 6, 2006

(54) Apparatus and method of applying a coating to a substrate

(76) Inventor: Lawrence Alfred Jones, Tauranga (NZ)

Correspondence Address: KNOBBE MARTENS OLSON & BEAR LLP, 2040 MAIN STREET, FOURTEENTH FLOOR, IRVINE, CA, 92614, US

(21) Appl. No.: 11/026,522

(22) Filed: Dec. 30, 2004

(51) Int. Cl. B05D 3/02; B05D 3/00; B05D 7/00; B05C 11/00; B05B 1/00; B05B 15/00

(52) U.S. Cl. 427/299; 427/372.2; 427/421.1; 118/50; 118/600; 118/610; 118/300

(57) ABSTRACT

A method of applying a UV resistant coating to a substrate surface includes the steps of preparing the substrate surface, and applying a liquid to the substrate surface. During application of the liquid, the liquid is allowed to cascade across the substrate surface to form a UV-resistant coating upon the surface once dry. An apparatus for storing and supplying a UV-resistant coating liquid suitable for application to a substrate surface is also described. The apparatus has a least one supply chamber connected to an outlet port. The supply chamber is adapted to receive the liquid via at least one water removal device. The chamber is also adapted to provide the liquid with a pressure greater than ambient pressure conditions as it exits the outlet port.

### TECHNICAL FIELD

This invention relates to an apparatus and method of applying a coating to a substrate. In particular, though not solely, this invention relates to a method for applying a substantially ultra-violet resistant coating to a substrate surface and an apparatus for carrying out this method.

### BACKGROUND ART

Visible and invisible portions of the light spectrum can cause both physical damage (due to the energy contained within the light) and also chemical damage to objects, such as furniture, carpets, curtains and other fabrics based or covered objects for example, colored (stained) and treated wood; also causing irreversible damage to exposed human/animal skin.

The ultra-violet portion of the light spectrum in particular can be harmful and damaging, even once transmitted through transparent or semi-transparent mediums such as glass (windows for example). Some attempts to help solve or reduce this problem have included the application of a ultra-violet reducing or resistant skin or film being applied to the medium. For instance, the “tinting” of windows with a laminate is the main form by which the levels of light can be reduced from entering a vehicle, building or house.

Such laminate films are generally in the form of a colored plastic film having on one side a self- or pressure-sensitive adhesive for sticking to the transparent or semi-transparent medium. The remaining side of the film surface does not include an adhesive (as this side is exposed to external environmental conditions (either within or exterior of a vehicle, building or house window).

However a problem with these types of laminate or physical film coverings is that they often distort the light entering and consequently the view through the medium. In addition, application of the laminate can often be a tricky and difficult process, with crinkle, laminate overlap or fold marks being apparent in the laminate film applied to the medium surface. It can also be difficult to ensure the laminate is cut correctly or fitted to the same size of the medium surface requiring a UV light spectrum inhibitor.

A light spectrum inhibitor, in particular an inhibitor of sections of the light spectrum which cause significant harmful damage to objects, people and animals is desired which overcomes at least the problems described which exist in present laminate- or film-type applications.

A method or system of applying an inhibitor to a transparent or semi-transparent medium (for example, glass windows) is required which allows ease of application, whilst providing a useful level of light spectrum reducing capability (for example, reducing the amount of ultra-violet light allowed through a glass window).

An apparatus which allows the UV light spectrum inhibitor and method to be carried out would also be advantageous.

It is therefore an object of the present invention to provide an apparatus and/or method for applying a coating to a substrate which goes at least some way towards addressing the foregoing problems, or to at least provide the industry and/or public with a useful choice.

All references, including any patents or patent applications cited in this specification are hereby incorporated by reference. No admission is made that any reference constitutes prior art. The discussion of the references states what their authors assert, and the applicants reserve the right to challenge the accuracy and pertinence of the cited documents. It will be clearly understood that, although a number of prior art publications are referred to herein, this reference does not constitute an admission that any of these documents form part of the common general knowledge in the art, in New Zealand or in any other country.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

Further aspects and advantages of the present invention will become apparent from the ensuing description which is given by way of example only.

### SUMMARY OF INVENTION

Accordingly, in a first aspect, the present invention may be said to broadly provide a method of applying a UV resistant coating to a substrate surface including the steps of;

preparing the substrate surface;

applying a liquid to the substrate surface;

wherein the liquid during application is allowed to cascade across the substrate surface to form a UV resistant coating upon the surface once dry.

Preferably, preparing the substrate surface includes application of a priming agent onto the substrate surface to which the liquid can bind.

Preferably, preparing the substrate surface includes cleaning and/or substantially removing substrate surface contaminants, such as accumulated dirt and moisture.

Preferably, preparing the substrate surface includes applying a protective surface around the periphery of the substrate surface including;

applying a protective seal to the joints between the substrate surface and the substrate surface connection or support systems, and

forming a collection trough at the lower edge of the substrate surface, and

collecting any excess liquid which is flowing off of the substrate surface.

Preferably, any excess liquid collected in said collection trough is removed and either discarded or recycled to be re-applied to the substrate surface.

Preferably, any excess liquid is removed via a vacuum system.

Preferably, at least one tape is used to form the protective seal.

Preferably, the tape used to form the protective seal is chemically resistant to the components forming the liquid and/or priming agent.

Preferably, the collection trough is formed from the joining of a tape and plastic film, the plastic film being allowed to sag sufficiently to create a depressed region lower then the lowermost edge of the substrate surface.

Preferably, the liquid is an ultra-violet (UV) reducing liquid composition.

Preferably, the liquid includes a carrier solvent which evaporates out of the liquid, leaving a coating upon the substrate surface.

Preferably, the liquid binds with the priming agent.

Preferably, the liquid is applied to said substrate via an applicator at above ambient pressure conditions.

Preferably, prior to the liquid being applied to the substrate surface it is filtered to remove particulate matter and/or moisture.

Preferably, filtering for removal of particulates and/or moisture takes place in an apparatus having one or more filtrations means and/or one or more moisture removal devices.

Preferably, the liquid is held in at least one holding and/or supply chamber prior to application to the substrate.

Preferably, the holding chamber is maintained with a vacuum pressure, said vacuum pressure being able to be utilized to remove any excess liquid.

Preferably, said supply chamber is maintained with a positive pressure, thereby inducing liquid application to said substrate, via an applicator, to be greater than ambient pressure conditions.

Preferably, actuation of a valve allows liquid to flow from the supply chamber, through the applicator and onto said substrate.

Preferably, the coating reduces or eliminates more than 50% of the ultra-violet light within the light passing through the substrate.

Preferably, the coating reduces or eliminates more than 80% of the ultra-violet light within the light passing through the substrate.

Preferably, the coating reduces or eliminates up to 99% of the ultra-violet light within the light passing through the substrate.

Preferably, the substrate is glass.

Preferably, the substrate is a glass window pane.

According to a second aspect, the present invention may broadly be said to provide an apparatus for storing and supplying a UV resistant coating liquid suitable for application to a substrate surface,

the apparatus having a least one supply chamber connected to an outlet port,

with the at least one supply chamber being adapted to receive the liquid via at least one water removal device,

wherein the at least one chamber is adapted to provide the liquid, as it exits the outlet port, with a pressure greater than ambient pressure conditions.

Preferably, an actuator is used to ensure the liquid is at a pressure greater than ambient pressure conditions as it exits the outlet port.

Preferably, the actuator is a pump. Compressors and other types of pumping devices can be used.

Preferably, the at least one supply chamber is held under positive pressure in order to ensure the liquid exits the outlet port at a pressure greater than ambient pressure conditions.

Preferably, where the at least one supply chamber is pressurized by use of a gas, that gas is filtered of particles greater than 5 μm in size and passed through one or more water removal devices.

Preferably, the apparatus has at least one liquid holding chamber which holds a supply of the liquid prior to passing the liquid onto the supply chamber.

Preferably, the liquid is passed through one or more water removal devices prior to introduction to the at least one supply chamber.

Preferably, the liquid is passed through one or more water removal devices prior to introduction to the at least one holding chamber.

Preferably, a solvent is added to the liquid in the at least one supply chamber or in any of the water removal devices.

Preferably, a solvent is added to the liquid in the at least one holding chamber or in any of the water removal devices.

Preferably, filtration means filter the liquid and/or solvent and/or gas of particulate matter.

Preferably, the filtration means filter particulate matter of greater than substantially 5 μm in size.

Preferably, the outlet port includes a valve controlled applicator.

Preferably, the applicator is a length of tubing with a nozzle attached to the exit end for liquid distribution upon the substrate surface. For example, the applicator (or “wand”) can be formed from a length of copper tubing, which is sufficiently malleable to allow a person to bend or shape the applicator to make reaching angles or regions or the substrate surface easier.

Preferably, the at least one holding chamber is held under a vacuum and said vacuum is uutilized to aid removal of any excess liquid which flows off the substrate surface.

For example, a tube or hosing may be fitted to a port on the holding chamber, utilising the vacuum pressure/suction and then draining/drawing off any excess liquid which accumulates in the collection trough or which runs off the substrate surface. The excess liquid can then be recycled to the holding tank and filtered to remove particulates and any moisture entrained. Alternatively, the excess liquid collected can be filtered and have moisture removed in an intermediate step before re-introduction to the holding chamber.

Advantageously, the supply chamber is pressurized to approximately 10 p.s.i (or a positive pressure above ambient pressure conditions) and the holding chamber is operated at substantially negative 10 p.s.i. (pounds per square inch) (or 10 p.s.i below ambient pressure conditions). Of course, vacuum pressures greater than this can be operated at, dependent upon the structural strength and design of the chamber. The holding chamber can primarily be used as a receiving chamber for liquid and any additional solvent needing to be added to the liquid.

Preferably, the liquid is an ultra-violet (UV) reducing liquid composition.

Preferably, the liquid includes a carrier solvent which evaporates out of the liquid, leaving a coating upon the substrate surface. For example, such a priming agent may be a fluid of around 60% alcohol composition. The priming agent preferably adheres to the substrate surface, and the liquid then adheres to the priming agent—subsequently forming the coating required.

### BRIEF DESCRIPTION OF DRAWINGS

Further aspects of the present invention will become apparent from the following description which is given by way of example only and with reference to the accompanying drawings in which:

FIG. 1 illustrates an embodiment of the apparatus of the present invention from a frontal elevation;

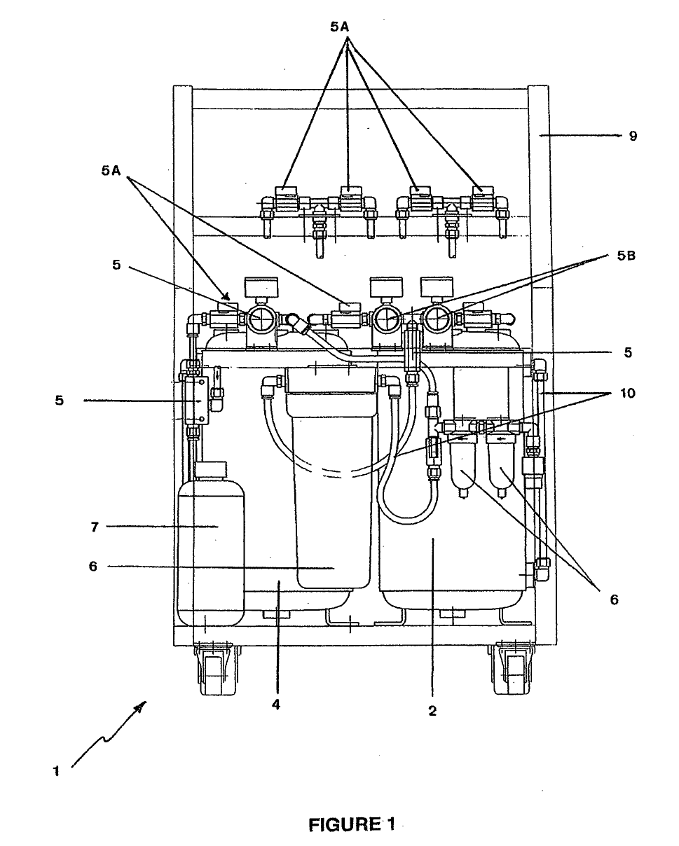

FIG. 2 illustrates a top (or plan) view of the embodiment of FIG. 1;

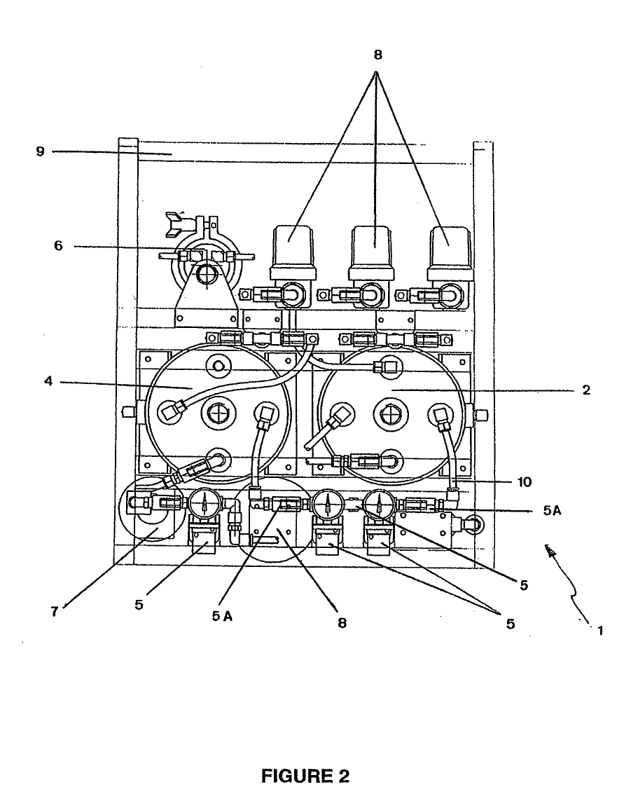

FIG. 3 illustrates the same apparatus from a first side elevation; illustrates the back elevation;

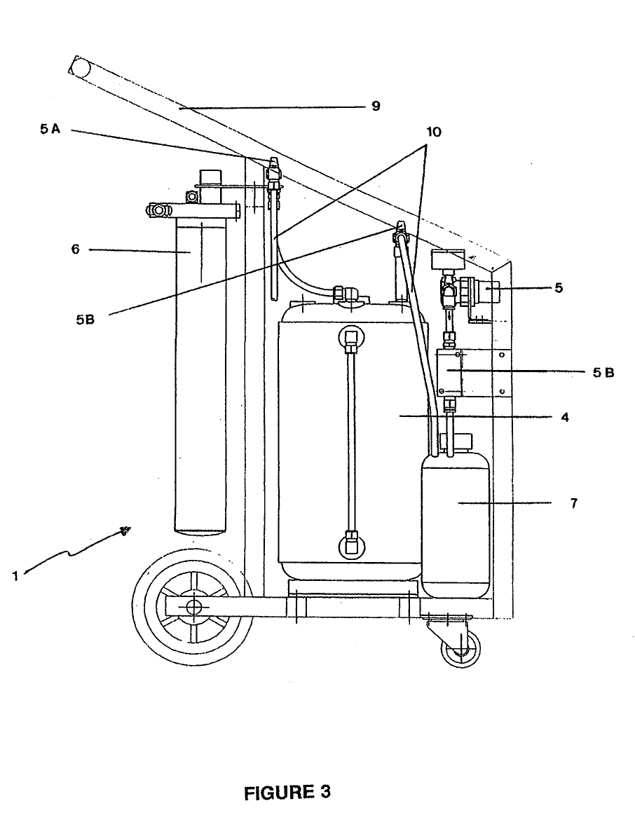

FIG. 4 illustrates the same apparatus from a second side elevation;

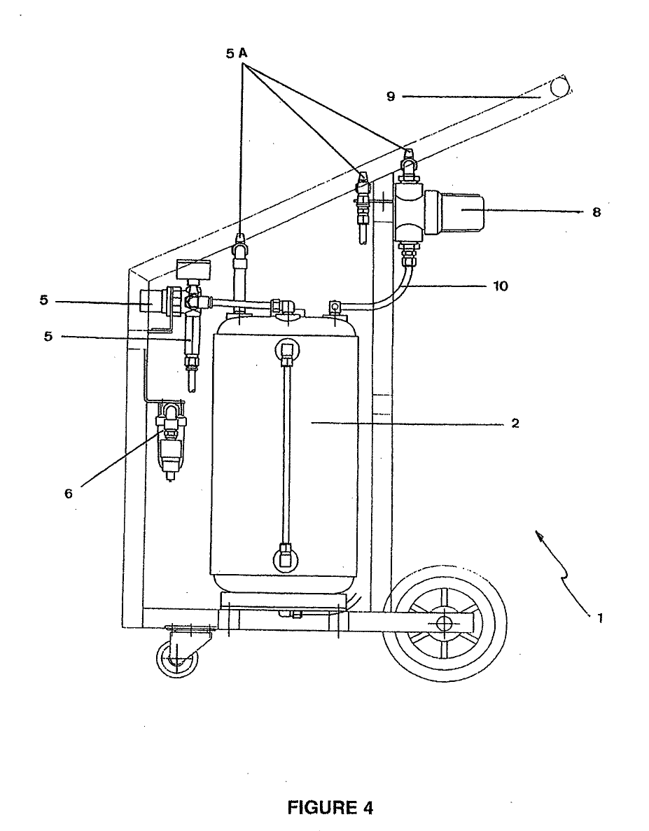

FIG. 5 illustrates the same view of FIG. 4 with some equipment partially exposed;

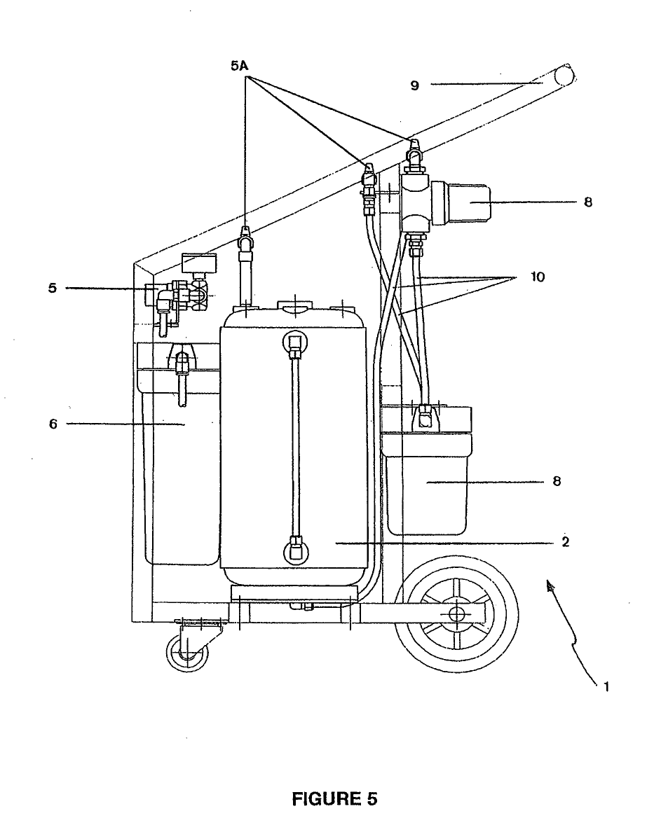

FIG. 6 illustrates the same apparatus embodiment from a rear (or back) elevation view;

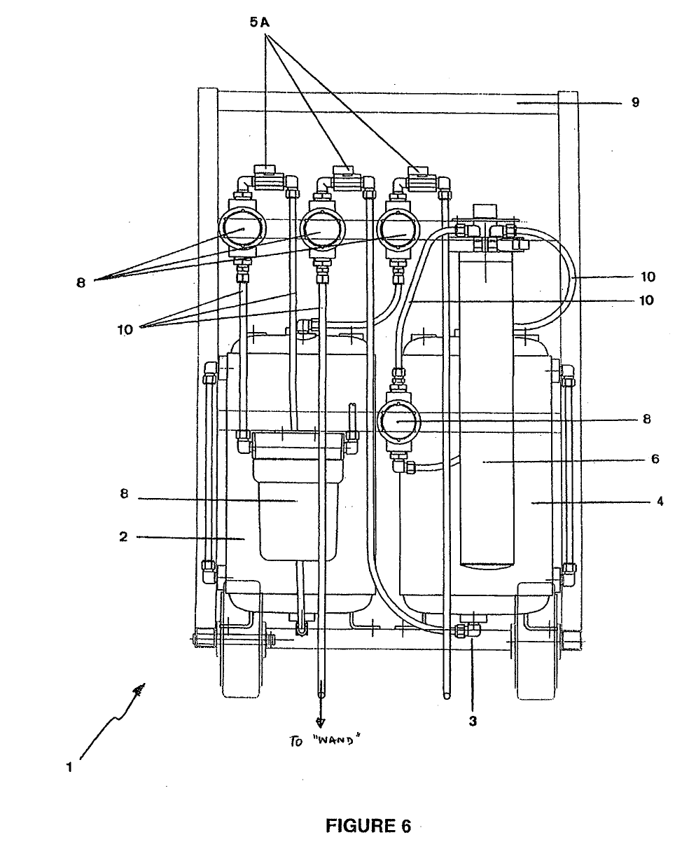

FIG. 7 illustrates the same features of FIG. 6 in which some tubing hidden detailing is shown;

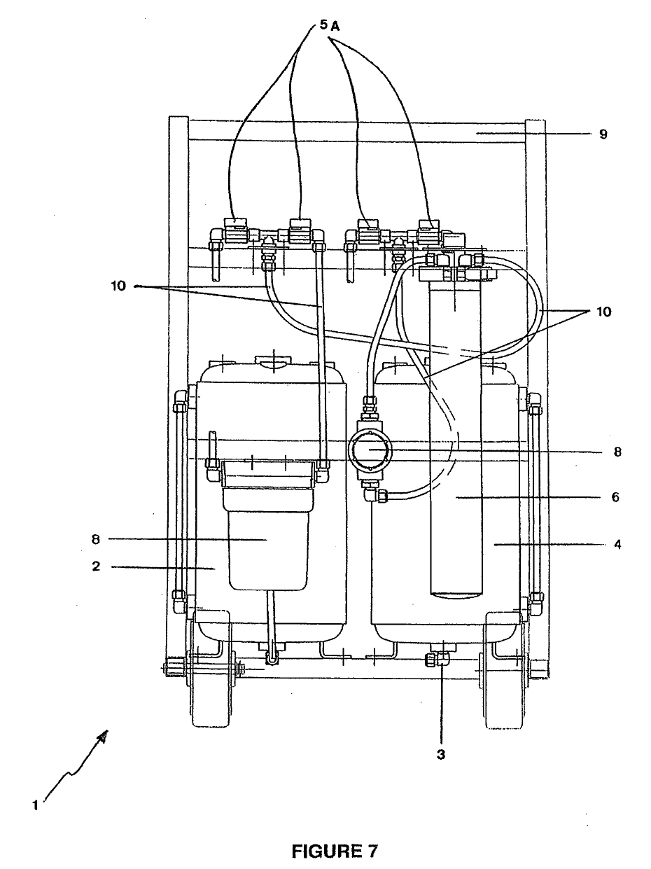

FIG. 8 illustrates an embodiment of an air supply system for use with the present invention; and

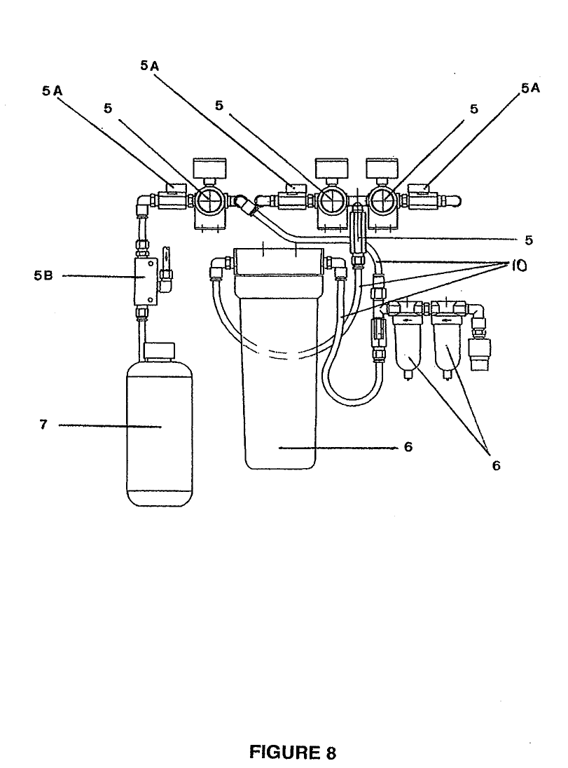

FIG. 9 illustrates a simplified view of a substrate surface with collection trough in position.

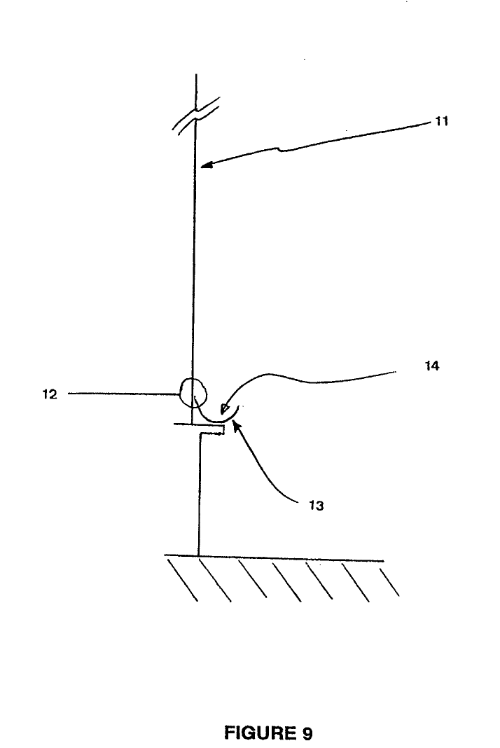

### DETAILED DESCRIPTION OF THE INVENTION

The present invention will now be described with reference to the accompanying drawings. Reference to the term “UV resistant” coating shall mean a coating which when formed substantially creates a barrier to or at least reduces or eliminates the amount of ultra-violet spectrum light from passing through the formed coating. The term “coating” refers to the film which is formed once a liquid, as applied to a substrate surface (11), has cured. The liquid cures to form a substantially resilient surface able to withstand at least some abrasion and knocks or contacts without being physically deteriorated. Ideally, a relatively robust coating is achieved.

One aspect of the present invention lies in a method of application of a liquid which forms a UV resistant coating on a substrate surface (11), such as a glass window pane, as well as an apparatus (1) which allows suitable storage and pre-application treatment facilities for the liquid used.

The liquid used should ideally have a viscosity which allows a user to apply the liquid at a suitable rate to a substrate surface (11) and which allows the liquid to cascade or flow in a generally uniform manner over the surface. Allowing a cascading flow of liquid over the surface ideally allows coverage of all surface area of the substrate, which, upon curing, forms coating.

Advantageously, in a first aspect the present invention provides a method of applying a UV resistant coating to a substrate surface (11) including the steps of; preparing the substrate surface; and then applying a liquid to the substrate surface; wherein the liquid during application is allowed to cascade across the substrate surface to form a UV resistant coating upon the surface once dry.

Such a liquid used should have laminar flow tendencies, or at least allow a useful cascading or flow tendencies across the substrate surface ensuring a uniform or substantially even coating formation.

Such a method allows ease of application of a liquid to a substrate surface, such as a glass window pane, by allowing the liquid to cascade across the surface. Preparation of the substrate surface includes application of a priming agent onto the substrate surface to which the liquid can subsequently bind to and form the UV resistant coating. Ideally, such a priming agent is 60% alcohol.

In a preferred embodiment the priming agent is an alcohol containing fluid and binds to the substrate surface, which allows the liquid to bind to the priming agent (and this the substrate) to form the coating.

The priming agent can be applied to the substrate surface (11) manually using a cloth which has an amount of the priming agent absorbed onto or into it. Following the application of the priming agent to the substrate surface, the substrate surface may then have the UV resistant coating liquid applied, described in further detail below.

Additionally, prior to the application of the priming agent, as previously described the substrate surface is preferably cleaned to remove any particulate or dirt matter which has accumulated on the substrate surface.

The substrate surface preparation phase of the method optionally also includes cleaning and/or substantially removing substrate surface contaminants, such as accumulated dirt and moisture. Any moisture of dirt upon the substrate surface could interfere with the application of either the priming agent or formation of a substantially uniform UV resistant coating. Particles of dirt (or other materials such as flecks of paint or remnants of stickers or spilt food or beverage) could disrupt the cascade or flow of liquid across the substrate surface (11).

The primer and/or UV resistant coating liquid may be detrimentally affected by contact with or detrimentally affect the bonding agent or products (such as tapes) used to hold a substrate surface in position or within the support frame (generally the protective seal is in the region indicated by (12)). In order to protect the framing (as well as the quality of the liquid) a protective sheath or covering (such as a tape) should be applied as a protective layer, such a masking tape or similar located around the periphery of the substrate surface. This prevents contact of the priming agent and/or liquid with substrate surface surroundings.

The application of a protective surface around the periphery of the substrate surface includes the steps of; applying a protective layer or seal (such as by use of one or more tapes) to the joints between the substrate surface and the substrate surface connection or support systems, and forming a collection trough (13) at the lower edge of the substrate surface, and then collecting any excess liquid which is flowing off of the substrate surface (11). One or more tapes (for example a one sided adhesive tape) can be used to form the protective seal over joints framing around windows or, for example, over the putty used to hold a glass window pane within a wooden frame, or the rubber seal on aluminium joinery. Ideally, such tapes or their adhesive, do not corrode and/or are chemically resistant to contact with the priming agent or UV coating liquid.

Advantageously, the collection trough (13) is formed from the joining of adhesive tape and a length of wide plastic film (also known as a “skirt tape”). The adhesive tape is attached to the lower edge of the substrate surface, with the plastic film extending away therefrom. The plastic film is then allowed to sag sufficiently to create a depressed region lower then the lowermost edge of the substrate surface and maintained in this position by the attachment of further adhesive tape to hold the film in a suitable sag or depression. This sag can then be used to collect liquid draining off the substrate surface lower edge.

Any of the excess liquid collected in the collection trough, at location indicated by arrow (14) is removed and either discarded or recycled to be re-applied to the substrate surface. Removal of this excess liquid can be affected by either a siphon or via a vacuum system. For example, the holding chamber (2) is held under a vacuum and this vacuum can be utilized to aid removal of any excess liquid which flows off the substrate surface (11).

A hose connected to the apparatus 1 can utilize the vacuum created by the compressed air/venture system. Such a hose is used to suck the excess liquid product from the collection trough (13) at location (14) and return the product to the holding chamber.

In an embodiment of the present invention, the outlet port (3) of the apparatus supply chamber (4) includes and is attached to a length of hosing or flexible tubing with a valve controlled applicator or “wand” (not shown) at its end. The wand is used to apply the liquid to the surface. A suitable applicator is a length of tubing with a nozzle attached to the exit end (of the application or “wand”), for liquid distribution upon the substrate surface or similar such device.

Ideally, the method of application provides that application of the liquid begins at a lowermost corner of a substrate surface, proceeding up the edge or periphery of the surface until the top edge is reached. Once the top edge is reached, liquid application should continue across the surface at a rate which allows liquid to cascade across the surface area below (and preferably at an excess rate of liquid application such that an excess of liquid pools in the collection trough below).

Liquid application continues until the applicator (with liquid streaming/flowing out of it) reaches the opposing edge of the surface, before then allowing the liquid to be applied to the opposite most edge of the surface (thus ensuring sufficient coverage and liquid application) to preferably ensure the entire surface has been covered with the liquid.

The liquid is allowed a period of time to cure. The curing process occurs as a result of two primary occurrences; firstly the evaporation of a solvent (carrier) from within the liquid itself, and secondly from contact with water (moisture) within the atmospheric environment surrounding the substrate surface (in other words, it air dries or cures).

Advantageously, the liquid cures upon contact with moisture. The liquid may have a latent catalyst contained within it which inhibits curing as well as a solvent which also inhibits curing of the liquid. Upon contact of the liquid with moisture (for example, within the surrounding environment of the substrate surface/atmosphere) the catalyst breaks down or allows the liquid to begin curing, in conjunction with evaporation or flashing off of solvent from the liquid into the surrounding environment/atmospheres. A balance of catalyst and solvent within the liquid is required in order to allow the liquid to be applied with suitable viscosity characteristics to the substrate surface without curing too quickly upon the surface, and instead allows the liquid to cascade or flow over the surface before then curing in time. After application of the liquid to the substrate surface the coating begins to form and is tack free after approximately two hours. However, after 24 or even 48 hours, the coating should have substantially cured and formed a robust coating.

As mentioned above, the liquid used can be cured under two conditions, the evaporation of solvent and contact with moisture and air. Therefore, in-order for the liquid to be prevented from curing prematurely, that is either within the apparatus itself or too soon upon contact with the surface, both the solvent level in the liquid needs to be maintained at a certain level; and any entrained moisture (in the liquid or air which enters the apparatus) needs to be scrubbed and treated to remove, at least a liquid curing amount of, water (moisture).

Air is removed from within the apparatus system by removing air from the holding chamber by generating a vacuum in the chamber or using a suction created by the vacuum or suitable venture vacuum erecting system. Once air is removed from this section of the apparatus, the liquid (and solvent) can be pumped or transferred to the supply chamber (4). Transfer of the liquid can be undertaken by suitable actuating positive displacement pumps, siphons or similar systems which require control valves (5) to be utilized where necessary. The various pressures within the holding and supply chambers are controlled by a valve system arrangement.

Air pressure is supplied to the system for use in charging the pressure of the supply chamber and in conjunction with a venture device the air flow can generate a suitably required vacuum pressure in the holding tank/chamber.

Air is supplied via an air compressor (not shown in illustrations) which is of a suitable compression capacity to enable positive pressure charging of the supply chamber, and able to work with a venture device (labelled as item 11), the venture device which operates to provide suction and consequently a vacuum to the holding chamber (2).

Although of course, other suitable liquids or solvent carriers could be used to ensure the liquid is able to be effectively applied to the substrate surface, which afterwards then cures or dries (to form a coating capable of providing at least some ultra-violet resistance).

In a second aspect, there is provided an apparatus (1) for storing and supplying a UV resistant coating liquid suitable for application to a substrate surface, the apparatus having a least one supply chamber (4) connected to an outlet port (3), (which connects the “wand” to the apparatus) with the at least one supply chamber (4) being adapted to receive the liquid via at least one water removal device (6), wherein the at least one chamber is adapted to provide the liquid, as it exits the outlet port (3), with a pressure greater than ambient pressure conditions.

An exhaust plenum or muffler system/chamber (7) is also employed to disperse the compressed gas/air after it has been used in the apparatus. This exhaust is configured to ideally ensure that the pressurized gas does not eject directly onto the floor, which could lift and elevate particles which could then stick or attach to the substrate surface or the semi-cured coating. For example, the walls and/or top of the exhaust may be perforated to allow the gas to escape/disperse.

Such an outlet port pressure can be achieved by either pressurising the supply chamber (4) itself, or by the use of a (or air valve system) positive displacement pump or compressor or similar actuator in order to provide a positive pressure flow of liquid at the outlet port or of an suitable applicator. Such systems require these non-return valves or pressure regulators (5), as and where necessary in equipment. Suitable control or operating switches for the valves are labelled as ‘5A’. Further, suitable valves 5, 5A can be used to control and adjust the rate of liquid product transfer from holding to supply chamber, through each of the filters or moisture removal devices. A valve (5B) is able to be used to adjust and control the level of venturi suction generated by the air flow.

Where pressurisation of the chamber occurs (via the use of pressurized air or other gases), the air (or gas) needs to be filtered to remove any particulate matter and dried to remove any moisture (which would initiate liquid curing). Filtration can be undertaken by filters which remove particles greater than about 5 μm in size. Drying of the gas (or air) can be undertaken by passing it through a water removal device (6), such as silicon beads or condensers or other suitable moisture removal means.

The apparatus (1) can also have at least one liquid holding chamber (2) which holds a supply of the liquid prior to passing the liquid onto the supply chamber (4). Any number of holding or storage chambers can be used with the apparatus depending upon the size of the job being undertaken or requirements of the apparatus.

As moisture (water) is a factor in allowing the liquid to cure or “set”, the liquid is passed through one or more water removal devices (6) prior to introduction to a supply chamber (4). Such water removal devices (6) may include silicon bead filled reservoirs or other drying devices, such as condensers. Such a moisture/ water removal system should also be applied to liquid being transferred to, or introduced to the holding chambers(s) (2) or supply chamber(s) (4).

A certain quantity of solvent will evaporate from the liquid either during transfer of the liquid to the apparatus itself, or as a result of the excess liquid collected from the collection trough which will be depleted of solvent. Therefore, in order to ensure that the UV resistant coating liquid remains of a desirable viscosity, and does not cure, additional solvent may be added to the liquid. This may take place in the supply chamber(s) (4) and/or holding chamber(s) (2) or at any of the water removal devices (6).

Further, during cleaning operations of the apparatus equipment, the solvent is used to flush the various chambers, tubing and water removal devices of the liquid—otherwise any liquid remaining in the system which comes into contact with moisture will begin to cure and set (which is undesirable inside the apparatus).

Therefore, by flushing the apparatus with the solvent, the solvent picks up and entrains any liquid remaining in any part of the apparatus and flushes it to a discharge point (not shown). This cleaning and flushing operation of the apparatus can also serve to reintroduce fresh solvent into the liquid when the apparatus is next charged with a fresh batch or amount of liquid for application to a substrate surface. This can be done, for example, following the flushing operation with the solvent used in this process as a cleaning product/material. The solvent passes through the water removal devices, flushing out any moisture, and at the same time replacing the water or moisture with an amount of solvent. That solvent remains in place in the water removal device until the apparatus is next used and liquid is passed through the water removal device, at the same time picking up the solvent which has remained in the water removal device. This is one form of reintroducing solvent into the apparatus, of course the applicants realize that a number of other similar systems may be used to introduce solvents. For example, solvent may be introduced directly to any one of the chambers and/or water removal devices directly also.

Ideally the solvent is not water soluble, or does not have an affinity for entraining moisture, however where moisture is entrained by the solvent, this needs to be removed. Therefore, the solvent also needs to be filtered of any entrained particles and have all or a substantial part of any moisture (water) removed prior to its introduction with or to the UV coating liquid.

The apparatus (1) of the present invention is provided to ideally ensure that a minimum of moisture is allowed to be entrained within the liquid contained within either the holding (2) or supply chambers (4). The apparatus (1) also allows for the addition of extra solvent (when necessary) to ensure the liquid contains sufficient carrier solvent (which eventually either evaporates (flashes) off from the liquid upon application to the surface, or which remains with the liquid and is re-collected from any excess liquid collected and recycled).

One or more filters (8) are also employed to ensure that particulate matter in the liquid or solvent (when added separately) or air (gas) are removed. Any solid matter or particles which become entrained or caught in the liquid being applied to the substrate surface would cause undesirable imperfections in the quality of the final coating formed.

Ideally, the coating will eliminate up to 50% of ultra violet light passing through the coating attached to the substrate. Even more preferably though, up to 80% of ultra violet light is eliminated, although most preferably up to 99% of UV light is eliminated. These properties are those of the coating composition used. Suitable coating compositions can be used which have these characteristics/properties and which can have a suitable viscosity (or can be modified using solvents or other carrier fluids or additives as necessary to meet the UV elimination requirements or viscosity suitable for use with the apparatus).

In an embodiment of the present invention filters (8) are located on the inlet (or liquid/solvent introduction) end of the apparatus configuration for filtration as the fluids are drawn into the apparatus. These filters can be of any suitable filtration capability, although in the embodiment shown, four filters each of 5 μm (micron) sized filtration ability are utilized. A larger particulate filter is also used to remove bigger particles or debris—which may for example have become by ensuring that particles above 5 μm in size are removed from the liquid (solvent and/or priming agent) being applied to the substrate surface, the quality (and clarity) of all the fluids are ensured and allow a high level of consistency and clarity of the coating thus formed. Similarly particles in any air (gas) used to pressurize the supply chamber need to be removed.

The entire apparatus can be mounted on a mobile frame (9) to enable a user to easily transport the equipment about a building. Advantageously the width of such a frame and equipment should be not greater than the width of a door frame. The frame can also provide protection to the equipment from general knocks and other undesired contacts.

Where necessary one-way (“non-return”) valves and pressure controlling or sealing systems are also employed to prevent undesirable leakage of pressure of liquids within the apparatus system. Pressure gauges are also used to help an apparatus user evaluate operation of the system.

Suitable corrosion or chemical resistant tubing or hosing (10) is used to connect the apparatus configuration and each of the filters (8), moisture removal devices (6), holding (2) and supply chambers (4). In an alternative embodiment, easily removable and replaceable tubing can be used which is replaced and/or cleaned during regular maintenance intervals to ensure the quality and integrity of the equipment used. In a further alternative, suitably corrosion resistant tubing, such as stainless steel 304 or 316 can be used. The chambers (2,4) may also be made of such suitable materials in-order to minimize any liquid quality deterioration.

Some key advantages of the present invention include the result that the coating formed does not color the substrate surface (unless a separate coloring agent is optionally employed); there can be no crinkle, overlap or seams formed as no laminate plastic (or otherwise) film is used; just about any sized surface can be relatively easily coated (compared to existing laminating systems); no bubbling or lifting of the coating occurs as can often happen with the laminate products; nor does it deteriorate the architectural integrity of a building (that is, the windows are not colored compared to the usual UV darkened laminate films).

Aspects of the present invention have been described by way of example only and it should be appreciated that modifications and additions may be made thereto without departing from the scope thereof.

What is claimed is:

1. A method of applying a UV-resistant coating to a substrate surface comprising:
a. preparing the substrate surface;
b. applying a liquid to the substrate surface by cascading the liquid across the substrate surface; and
c. drying the liquid to form the UV-resistant coating upon the surface.

2. A method as claimed in claim 1, wherein preparing the substrate surface includes application of a priming agent onto the substrate surface to which the liquid can bind.

3. A method as claimed in claim 1, wherein preparing the substrate surface includes cleaning and/or substantially removing substrate contaminants, such as accumulated dirt and moisture.

4. A method as claimed in claim 1, wherein preparing the substrate surface comprises applying a protective surface around the periphery of the substrate surface by a method comprising;
d. applying a protective seal to the joints between the substrate surface and the substrate surface connection or support systems, and
e. forming a collection trough at the lower edge of the substrate surface, and
f. collecting any excess liquid which is flowing off of the substrate surface.

5. A method as claimed in claim 4, wherein any excess liquid in said collection trough is removed and either discarded or recycled to be re-applied to the substrate surface.

6. A method as claimed in claim 4, wherein any excess liquid is removed via a vacuum system.

7. A method as claimed in claim 4, wherein at least one tape is used to form the protective seal.

8. A method as claimed in claim 7, wherein the tape used to form the protective seal is chemically resistant to the components forming the liquid and/or priming agent.

9. A method as claimed in claim 4, wherein the collection trough is formed from the joining of a tape and plastic film, the plastic film being allowed to sag sufficiently to create a depressed region lower than the lowermost edge of the substrate surface.

10. A method as claimed in claim 1, wherein the liquid is an ultra-violet (UV) reducing liquid composition.

11. A method as claimed in claim 1, wherein the liquid includes a carrier solvent which evaporates out of the liquid, leaving a coating upon the substrate surface.

12. A method as claimed in claim 2, wherein the liquid binds with the priming agent.

13. A method as claimed in claim 1, wherein the liquid is applied to said substrate via an applicator at above ambient pressure conditions.

14. A method as claimed in claim 1, wherein prior to the liquid being applied to the substrate surface it is filtered to remove particulate matter and/or moisture.

15. A method as claimed in claim 14, wherein filtering for removal of particulates and/or moisture takes place in an apparatus having one or more filtration means and/or one or more moisture removal devices.

16. A method as claimed in claim 1, wherein the liquid is held in at least one holding and/or supply chamber prior to application to the substrate.

17. A method as claimed in claim 16, wherein the holding chamber is maintained with a vacuum pressure, said vacuum pressure being able to be utilized to remove any excess liquid.

18. A method as claimed in claim 16, wherein said supply chamber is maintained with a positive pressure, thereby inducing liquid application to said substrate, via an applicator, to be greater than ambient pressure conditions.

19. A method as claimed in claim 18, wherein actuation of a valve allows liquid to flow from the supply chamber, through the applicator and onto said substrate.

20. A method as claimed in claim 1, wherein the coating reduces or eliminates more than 50% of the ultra-violet light within the light passing through the substrate.

21. A method as claimed in claim 1, wherein the coating reduces or eliminates more than 80% of the ultra-violet light within the light passing through the substrate.

22. A method as claimed in claim 1, wherein the coating reduces or eliminates up to 99% of the ultra-violet light within the light passing through the substrate.

23. A method as claimed in claim 1, wherein the substrate is glass.

24. A method as claimed in claim 1, wherein the substrate is a glass window pane.

25. An apparatus for storing and supplying a UV resistant coating liquid suitable for application to a substrate surface, the apparatus comprising at least one supply chamber connected to an outlet port, and at least one water removal device,
g. the at least one supply chamber being adapted to receive the liquid via the at least one water removal device,
h. wherein the at least one chamber is adapted to provide the liquid, as it exits the outlet port, with a pressure greater than ambient pressure conditions.

26. An apparatus as claimed in claim 25, wherein an actuator is used to ensure the liquid is at a pressure greater than ambient pressure conditions.

27. An apparatus as claimed in claim 26, wherein the actuator is a pump.

28. An apparatus as claimed in claim 25, wherein the at least one supply chamber is held under positive pressure in order to ensure the liquid exits the outlet port at a pressure greater than ambient pressure conditions.

29. An apparatus as claimed in claim 25, wherein the at least one supply chamber is pressurized by use of a gas, and said gas is filtered of particles greater than 5 μm in size and passed through one or more water removal devices.

30. An apparatus as claimed in claim 25, wherein the apparatus has at least one liquid holding chamber which holds a supply of the liquid prior to passing the liquid onto the supply chamber.

31. An apparatus as claimed in any claim 25, wherein the liquid is passed through one or more water removal devices prior to introduction to the at least one supply chamber.

32. An apparatus as claimed in claim 25, wherein the liquid is passed through one or more water removal devices prior to the introduction to at least one holding chamber.

33. An apparatus as claimed in claim 25, wherein a solvent is added to the liquid in the at least one supply chamber or in any of the water removal devices.

34. An apparatus as claimed in claim 30, wherein a solvent is added to the liquid in the at least one holding chamber or in any of the water removal devices.

35. An apparatus as claimed in claim 26, wherein filtration means filter the liquid and/or solvent and/or gas of particulate matter.

36. An apparatus as claimed in claim 35, wherein the filtration means filter particulate matter of greater than substantially 5 μm in size.

37. An apparatus as claimed in any claim 26, wherein the outlet port includes a valve controlled applicator.

38. An apparatus as claimed in claim 37, wherein the applicator is a length of tubing with a nozzle attached to the exit end for liquid distribution upon the substrate surface.

39. An apparatus as claimed in any claim 33, wherein the at least one holding chamber is held under a vacuum and said vacuum is utilized to aid removal of any excess liquid which flows off the substrate surface.

40. An apparatus as claimed in claim 26, wherein the liquid is an ultra-violet (UV) reducing liquid composition.

41. An apparatus as claimed in claim 26, wherein the liquid includes a carrier solvent which evaporates out of the liquid, leaving a coating upon the substrate surface.

42. An apparatus as claimed in claim 26, wherein the coating reduces or eliminates more than 50% of the ultra-violet light within the light passing through the substrate.

43. An apparatus as claimed in claim 26, wherein the coating reduces or eliminates more than 80% of the ultra-violet light within the light passing through the substrate.

44. An apparatus as claimed in claim 26, wherein the coating reduces or eliminates up to 99% of the ultra-violet light within the light passing through the substrate.

45. An apparatus as claimed in claim 26, wherein the substrate is glass.
